(19) United States
(12) Patent Application Publication
(10) Pub. No.: US 2025/0058480 A1
(43) Pub. Date: Feb. 20, 2025

(54) Tool Flange, Mounting Arrangement, Tool and Industrial Robot

(71) Applicant: ABB Schweiz AG, Baden (CH)

(72) Inventors: Tomas Botold, Västerås (SE); Shanghua Li, Västerås (SE)

(21) Appl. No.: 18/720,742

(22) PCT Filed: Dec. 21, 2021
(86) PCT No.: PCT/EP2021/087058

§ 371 Date: Jun. 17, 2024

(51) Int. Cl. B25J 15/04

(52) U.S. Cl. CPC B25J 15/04

(57) ABSTRACT

A tool flange (22a) for an industrial robot (10), the tool flange (22a) comprising a distal surface (44) to which a tool (16a; 16b) for the industrial robot (10) can be secured; an external primary surface (46) facing outwards with respect to a central axis (34); an external distal groove (48) enclosing the central axis (34) and configured to receive an external distal static seal (88) to seal a primary gap (102) between the external primary surface (46) and the tool (16a; 16b) when the tool (16a; 16b) is secured to the distal surface (44), the external distal groove (48) separating the distal surface (44) and the external primary surface (46); and a tool flange connector (49a-49c) for being connected to a tool connector (97a-97c) of the tool (16a; 16b) when the tool (16a; 16b) is secured to the distal surface (44), the tool flange connector (49a-49c) being enclosed by the distal surface (44).

### TECHNICAL FIELD

The present disclosure generally relates to tool flanges and tools for an industrial robot. In particular a tool flange for an industrial robot, a mounting arrangement comprising a tool flange, a tool for an industrial robot, and an industrial robot comprising a tool flange, a mounting arrangement or a tool, are provided.

### BACKGROUND

In some processing environments, it is desirable to maintain a high level of hygiene. Examples of such processing environments include environments where food, beverages or pharmaceuticals are handled by an industrial robot. Any sanitary problem in such processing environment might result in catastrophic consequences. For this reason, comprehensive cleaning of the industrial robot is often performed on a daily basis. Typical cleaning procedures include high pressure washing with hot water and chemical agents, such as strong acidic or alkaline detergents and disinfectants. However, even after thorough and systematic cleaning, there is a risk that contaminants remain in interfaces between parts.

US2019193262 A1 discloses an articulated arm apparatus said to be leak tight as regards air, process fluids, and cleaning fluids. The articulated arm apparatus comprises a first arm segment, a second arm segment rotatable relative to the first arm segment at an elbow joint, and an end effector rotatable relative to the second arm segment at an end joint. The elbow joint comprises an elbow housing of the first arm segment, an elbow housing of the second arm segment, a spindle coupled rigidly to the elbow housing of the first arm segment, and a hub coupled to the elbow housing of the second arm segment. A static seal member can be used between the hub and the elbow housing of the second arm segment. The spindle can be hollow to allow for a feed through for components. The end joint can be similar to the elbow joint. US 2019193262 A1 does not describe a tool flange or how such tool flange can be provided with a hygienic design.

### SUMMARY

One object of the invention is to provide an improved tool flange for an industrial robot.

A further object of the invention is to provide an improved mounting arrangement for an industrial robot.

A still further object of the invention is to provide an improved tool for an industrial robot.

A still further object of the invention is to provide an improved industrial robot.

These objects are achieved by the tool flange, the mounting arrangement, the tool and the industrial robot according to the independent claims.

The invention is based on the realization that by providing a tool flange having a mating surface surrounded by an external static seal and a connector surrounded by the mating surface, a tool that does not necessarily have any features dedicated to improve its hygienic design can easily be attached to the tool flange to provide a very hygienic design of the tool flange and the tool together.

According to a first aspect, there is provided a tool flange for an industrial robot, the tool flange comprising a distal surface to which a tool for the industrial robot can be secured; an external primary surface facing outwards with respect to a central axis; an external distal groove enclosing the central axis and configured to receive an external distal static seal to seal a primary gap between the external primary surface and the tool when the tool is secured to the distal surface, the external distal groove separating the distal surface and the external primary surface; and a tool flange connector for being connected to a tool connector of the tool when the tool is secured to the distal surface, the tool flange connector being enclosed by the distal surface.

When the tool is secured to the tool flange, for example with one or more fasteners, the external distal static seal seals the primary gap at an exterior of the tool flange. The tool flange thereby enables many different types of existing “unhygienic” tools (e.g. tools that does not necessarily have any features dedicated to improve its hygienic design) to fulfill a hygienic design requirement imposed on the industrial robot. In this way, the tool flange enables a tool of many different existing designs to remain connected to the tool flange during a washdown process.

The tool flange also enables the tool connector to be connected to the tool flange connector and the external distal static seal to be compressed with a common mounting movement of the tool. Attachment and detachment of the tool to/from the tool flange is therefore facilitated.

Due to the external distal groove being positioned externally of the distal surface and distal of the external primary surface, the external distal groove can receive the external distal static seal in a way that provides a tight seal without providing any dust pockets. The tool flange thus provides a very hygienic design that is robust against harsh washdown environments. As a consequence, cleaning intervals can be prolonged. The external distal groove may be said to be positioned at an imaginary junction between the distal surface and the external primary surface.

Furthermore, due to combination of the tool flange connector and the external distal groove for receiving external distal static seal, the tool flange enables an improved protection of a line to the tool via the tool flange connector. Examples of lines according to the present disclosure comprise power cables, signal cables, liquid lines, vacuum lines, input air lines and output air lines. Each tool flange connector may thus for example be an electric power connector, an electric signal connector, a liquid connector, a vacuum connector or an air connector.

The tool flange may further comprise the external distal static seal received in the external distal groove. The external distal static seal may enclose the tool flange.

As used herein, a distal direction with respect to the tool flange is a direction towards the tool, and a proximal direction is a direction opposite to the distal direction.

The distal surface may provide a mating surface for mating with the tool. The distal surface may be substantially transverse, or transverse, to the central axis.

Throughout the present disclosure, the tool flange may be rotatable about the central axis. The tool may for example comprise a gripper, a vacuum device or a magnetic device.

At least a part of the external primary surface, such as the entire external primary surface, may be cylindrical and concentric with the central axis. In this case, the external primary surface faces radially outwards with respect to the central axis. In any case, the external primary surface may face an external region of the industrial robot.

The external distal groove constitutes an integrated sealing groove for the external distal static seal between the tool flange and the tool. The external distal groove may lie in a plane transverse to the central axis. The external distal groove may surround the entire tool flange.

The external distal groove may face in the distal direction, i.e. towards the tool. The external distal groove may optionally also face away from the central axis. The external distal groove may be at least partially open in a direction away from the central axis, i.e. at least partly facing towards the external region. The external distal groove may be configured to deform the external distal static seal both radially and axially with respect to the central axis.

The tool flange may comprise a mounting section. In this case, the distal surface, the external primary surface, the external distal groove and the tool flange connector may be provided in the mounting section.

The tool flange may further comprise a collar. The collar may protrude from the mounting section in the proximal direction. The mounting section may protrude outwards from the collar with respect to the central axis. The mounting section and the collar may be integrally formed in a single material.

The tool flange may comprise one or more primary mounting holes. Each primary mounting hole may extend through the tool flange. The tool flange may be secured to a rotatable output member of the industrial robot by means of one or more threaded primary fasteners, such as screws or bolts, passing through the primary mounting holes. Each primary mounting hole may pass through the collar.

The tool flange may comprise one tool flange connector or a plurality of tool flange connectors. The one or more tool flange connectors form a connection interface of the tool flange.

The tool flange may further comprise a through hole in which the tool flange connector is received. The tool flange may comprise one through hole associated with each tool flange connector. Alternatively, more than one tool flange connector may be received in a common through hole. In any case, each through hole may extend through the tool flange in parallel with the central axis.

The external distal groove may extend partly inside of the external primary surface in a plane transverse to the central axis. That is, the external primary surface may obstruct at least a part of the external distal groove when viewed in a radially inward direction with respect to the central axis.

The external distal groove may be curved and/or concave.

The tool flange may further comprise an internal distal groove in the distal surface inside of the external distal groove, the internal distal groove being configured to receive an internal distal static seal to seal against the tool when the tool is secured to the distal surface. The tool flange may further comprise the internal distal static seal received in the internal distal groove. The internal distal groove may be round, such as circular or oval.

The internal distal groove may be positioned outside the tool flange connector with respect to the central axis. The internal distal static seal thereby functions as a backup seal for the tool flange connector. Should the external distal static seal fail, this failure will be visible while the internal distal static seal still protects the tool flange connector.

The tool flange may further comprise a circular external proximal groove for receiving an external proximal dynamic seal to seal a secondary gap between the external primary surface and a secondary element. The tool flange may further comprise the external proximal dynamic seal received in the external proximal groove.

The external primary surface may be cylindrical and extend from the external distal groove to the external proximal groove. In this case, the external primary surface may be concentric with the central axis.

According to a second aspect, there is provided a mounting arrangement for an industrial robot, the mounting arrangement comprising the tool flange according to the first aspect and a secondary element. In this case, the secondary element may comprise an external secondary surface facing outwards with respect to the central axis. The external primary surface and the external secondary surface may be cylindrical and have the same diameter. The external primary surface and the external secondary surface may thus be flush and/or aligned. The secondary element may be fixed to a robot structure, such as a link, of the industrial robot. The external secondary surface may face the external region of the industrial robot.

The secondary element may comprise one or more secondary mounting holes. Each secondary mounting hole may extend through the secondary element. The secondary element may be secured to a link of the industrial robot by means of one or more threaded secondary fasteners, such as screws or bolts, passing through the secondary mounting holes.

The external proximal dynamic seal may seal the secondary gap between the external primary surface and the external secondary surface.

According to a third aspect, there is provided a tool for an industrial robot, the tool having a tool base comprising a proximal tool base surface for being secured to a distal surface of a tool flange of the industrial robot; an external tool base surface facing outwards with respect to a central axis; an external proximal tool base groove enclosing the central axis and configured to receive an external distal static seal to seal a primary gap between the external tool base surface and the tool flange when the tool is secured to the distal surface, the external proximal tool base groove separating the proximal tool base surface and the external tool base surface; and a tool connector for being connected to a tool flange connector of the tool flange when the tool is secured to the distal surface, the tool connector being enclosed by the proximal tool base surface. The proximal tool base surface may provide a mating surface for mating with the distal surface. The tool may further comprise an actuator, such as a gripper. The actuator may be controlled via the tool connector.

According to a fourth aspect, there is provided an industrial robot comprising a tool flange according to the first aspect, a mounting arrangement according to the second aspect, or a tool according to the third aspect. The industrial robot may be a hygienic industrial robot. The industrial robot may comprise a manipulator movable in three or more axes, such as in six or seven axes.

The industrial robot may further comprise the tool. The tool of this variant may or may not be a tool according to the third aspect. In any case, the tool is stationary with respect to the tool flange when the tool is secured to the distal surface. The external distal static seal is thus a stationary seal.

The tool of the industrial robot according to the fourth aspect may comprise a tool base. The tool base may comprise a proximal tool base surface. The proximal tool base surface may be flat. When the tool base is secured to the tool flange, the external distal static seal may be pushed into the external distal groove and/or into the external proximal tool base groove. The proximal tool base surface may mate with the distal surface when the tool is secured to the distal surface.

The external distal static seal may be compressed between the tool base and the tool flange when the tool is attached to the tool flange. In this way, the sealing is further improved. The external distal groove and/or the external proximal tool base groove may be shaped to cause both radial and axial deformation of the external distal static seal when the proximal tool base surface mates with the distal surface.

The tool base may comprise an external tool base surface. The external tool base surface may be flush and/or aligned with the external primary surface when the tool is secured to the tool flange. The external distal static seal may be configured to seal a primary gap between the external primary surface and the external tool base surface when the tool is secured to the tool flange.

Due to the external tool base surface and the external primary surface being flush and/or aligned when the tool is secured to the tool flange, and due to the external distal static seal sealing the primary gap between the external primary surface and the external tool base surface, there is a reduced risk that contaminants are accumulated in the region of the external distal static seal and the cleaning of the industrial robot can be improved. The external distal static seal makes sure that there is no gap between the external primary surface and the external tool base surface. Moreover, the design reliably ensures that water and washdown chemicals do not enter an internal region of the industrial robot, and that any oil or compressed air inside the internal region do not reach the external region. The industrial robot therefore provides a very hygienic design.

Furthermore, due to the external distal static seal seated in the external distal groove and/or in the external proximal tool base groove, there is no direct contact between the external tool base surface and the external primary surface. In many prior art industrial robots, a tool is connected to a tool flange with metal to metal contact externally. This is not wanted on hygienic industrial robots due to the growth risk of bacteria in this area.

The external tool base surface may face the external region of the industrial robot. The external tool base surface may be cylindrical and concentric with the central axis.

As an alternative or an addition to the internal distal groove for the internal distal static seal, the tool base may comprise an internal proximal groove in the proximal tool base surface configured to receive the internal distal static seal. The internal distal static seal may thus be compressed by the proximal tool base surface and/or by the distal surface in an axial direction with respect to the central axis when the tool is secured to the tool flange.

The tool base may be secured to the tool flange by means of one or more threaded tool fasteners, such as screws or bolts, passing through the tool mounting through holes and threadingly engaging respective tool mounting blind holes of the tool flange.

### BRIEF DESCRIPTION OF THE DRAWINGS

Further details, advantages and aspects of the present disclosure will become apparent from the following description taken in conjunction with the drawings, wherein:

FIG. 1: schematically represents a side view of an industrial robot comprising a tool flange;

FIG. 2: schematically represents a cross-sectional side view of the tool flange;

FIG. 3: schematically represents a cross-sectional side view of a mounting arrangement comprising the tool flange and a secondary element;

FIG. 4: schematically represents a cross-sectional side view of a link, the mounting arrangement and a tool of the industrial robot; and

FIG. 5: schematically represents a cross-sectional side view of the link, a further example of a mounting arrangement and a further example of a tool of the industrial robot.

### DETAILED DESCRIPTION

In the following, a tool flange for an industrial robot, a mounting arrangement comprising a tool flange, a tool for an industrial robot, and an industrial robot comprising a tool flange, a mounting arrangement and a tool, will be described. The same or similar reference numerals will be used to denote the same or similar structural features.

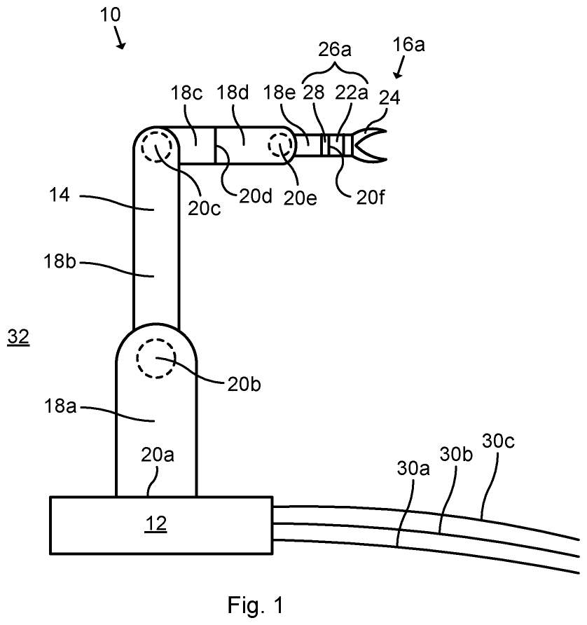

FIG. 1 schematically represents a side view of an industrial robot 10. The industrial robot 10 is here exemplified as a six axis industrial robot but the present disclosure is not limited to this type of robot. An industrial robot according to the present disclosure may comprise at least three axes.

The industrial robot 10 is a hygienic industrial robot. The industrial robot 10 can withstand harsh washdown processes.

The industrial robot 10 of this example comprises a base member 12, a manipulator 14 movable relative to the base member 12, and a tool 16a at a distal end of the manipulator 14. The manipulator 14 of this example comprises a first link 18a distal of the base member 12 and rotatable around a vertical axis relative to the base member 12 at a first joint 20a, a second link 18b distal of the first link 18a and rotatable around a horizontal axis relative to the first link 18a at a second joint 20b, a third link 18c distal of the second link 18b and rotatable around a horizontal axis relative to the second link 18b at a third joint 20c, a fourth link 18d distal of the third link 18c and rotatable relative to the third link 18c at a fourth joint 20d, a fifth link 18e distal of the fourth link 18d and rotatable relative to the fourth link 18d at a fifth joint 20e, and a sixth link distal of the fifth link 18e and rotatable relative to the fifth link 18e at a sixth joint 20f. The sixth link here comprises a tool flange 22a. The industrial robot 10 comprises an electric motor and a gearbox (not shown) for driving each joint 20a-20f.

The tool 16a is attached to the tool flange 22a. The tool 16a of this example comprises a gripper 24.

FIG. 1 further shows that the industrial robot 10 comprises a mounting arrangement 26a. The mounting arrangement 26a comprises the tool flange 22a and a secondary element 28. The secondary element 28 is secured to the fifth link 18e. The tool flange 22a is rotatable relative to the secondary element 28 at the sixth joint 20f.

The industrial robot 10 further comprises lines, here exemplified as a power and signal line 30a, an air input line 30b and an air output line 30c. The power and signal line 30a may be a so-called CPCS (customer power customer signal) cable. The power and signal line 30a transmits power and signals to the tool 16a for controlling the tool 16a. Pressurized air can be transferred to the tool 16a through the air input line 30b and return air from the tool 16a can be transferred back from the tool 16a through the air output line 30c. The power and signal line 30a, the air input line 30b and the air output line 30c are routed through the base member 12 and through the interior of the manipulator 14 all the way to the tool 16a.

The industrial robot 10 may be positioned in a room. In this case, the lines 30a-30c can be routed from the base member 12 to outside of the room. The entire room and the industrial robot 10 can thereby be subjected to a washdown process where for example hot pressurized water containing a cleaning agent is sprayed.

FIG. 1 further shows an external region 32. The external region 32 is a region outside the manipulator 14.

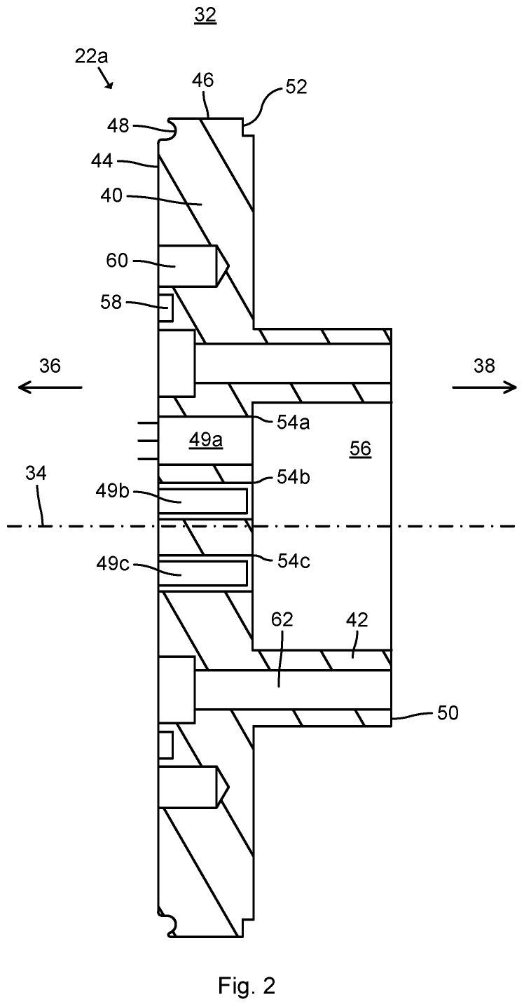

FIG. 2 schematically represents a cross-sectional side view of the tool flange 22a. The tool flange 22a is here rotatable about a central axis 34. In this example, the tool flange 22a is rotatable relative to the fifth link 18e about the central axis 34. The tool flange 22a may however be connected to other links of an industrial robot, such as rotatably connected to a sixth link of a seven axis industrial robot.

FIG. 2 shows a distal direction 36 and a proximal direction 38, opposite to the distal direction 36, with respect to the tool flange 22a. In this example, the distal direction 36 is a direction towards the tool 16a and the proximal direction 38 is a direction towards the fifth link 18e.

The tool flange 22a of this specific example comprises a mounting section 40 and a collar 42. The collar 42 protrudes from the mounting section 40 in the proximal direction 38. The mounting section 40 protrudes radially outwards from the collar 42 with respect to the central axis 34. The mounting section 40 and the collar 42 are here integrally formed from a single piece of material. The tool flange 22a may be made of metal, such as titanium, aluminum or stainless steel, for example AISI (American Iron and Steel Institute) 316 or AISI 316L stainless steels. The tool flange 22a of this example is an integral body, i.e. formed from a single piece of material. The tool flange 22a comprises a distal surface 44. The distal surface 44 of this example is flat and transverse to the central axis 34. The distal surface 44 faces in the distal direction 36. The distal surface 44 is here provided on the mounting section 40. In use of the tool 16a, the tool 16a is connected to the distal surface 44 which thereby provides a mating interface.

The tool flange 22a of this example further comprises a cylindrical external primary surface 46. The external primary surface 46 faces radially outwards with respect to the central axis 34. The external primary surface 46 faces towards the external region 32. The external primary surface 46 is concentric with the central axis 34. The external primary surface 46 may have a surface roughness profile, where an arithmetic mean deviation of the roughness profile, Ra, is less than 2 μm, such as less than 1 μm, such as less than 0.8 μm.

The tool flange 22a further comprises a circular external distal groove 48. The external distal groove 48 is configured to receive an external distal static seal. As shown, the external distal groove 48 is positioned at an imaginary junction between the distal surface 44 and external primary surface 46. The external distal groove 48 thereby separates the distal surface 44 and the external primary surface 46.

The external distal groove 48 is concentric with the central axis 34 and extends around the distal surface 44. The external distal groove 48 of this example is concave. The external distal groove 48 faces both in the distal direction 36 and away from the central axis 34 towards the external region 32. As shown in FIG. 2, a bottom of the external distal groove 48 in the proximal direction 38 is positioned radially inside the external primary surface 46 with respect to the central axis 34.

The external primary surface 46 is positioned proximally of the distal surface 44. Additionally, the distal surface 44 is positioned radially inside the external primary surface 46 and the external distal groove 48 with respect to the central axis 34.

The tool flange 22a of this example further comprises a plurality of tool flange connectors 49a-49c, here a first tool flange connector 49a, a second tool flange connector 49b and a third tool flange connector 49c. The first tool flange connector 49a, the second tool flange connector 49b and the third tool flange connector 49c are here exemplified as a power and signal connector for connection to the power and signal line 30a, an air input connector for connection to the air input line 30b, and an air output connector for connection to the air output line 30c, respectively. The first tool flange connector 49a comprises a plurality of contact pins. The second and third tool flange connectors 49b and 49c each comprises a hole. As shown in FIG. 2, the tool flange connectors 49a-49c are here aligned with the distal surface 44.

In this example, the first tool flange connector 49a is seated in a first through hole 54a of the tool flange 22a, the second tool flange connector 49b is seated in a second through hole 54b of the tool flange 22a, and the third tool flange connector 49c is seated in a third through hole 54c of the tool flange 22a. Each through hole 54 here passes through the tool flange 22a in parallel with the central axis 34. As shown in FIG. 2, each of the distal surface 44, the external primary surface 46, the external distal groove 48 and the tool flange connectors 49a-49c is provided in the mounting section 40.

The tool flange 22a of this example further comprises a proximal primary surface 50 transverse to the central axis 34 and facing in the proximal direction 38. The proximal primary surface 50 is here provided at a proximal end of the collar 42.

The tool flange 22a of this example further comprises a circular external proximal groove 52. The external proximal groove 52 is here positioned at a proximal side of the external primary surface 46. That is, the external primary surface 46 extends all the way from the external distal groove 48 to the external proximal groove 52. The external proximal groove 52 is configured to receive an external proximal dynamic seal.

FIG. 2 further shows an internal region 56. The internal region 56 is a region inside the manipulator 14.

The tool flange 22a of this example further comprises an internal distal groove 58. The internal distal groove 58 in FIG. 2 is circular and provided in the distal surface 44. The internal distal groove 58 faces in the distal direction 36. The internal distal groove 58 is positioned radially inside the external distal groove 48 and radially outside the tool flange connectors 49a-49c with respect to the central axis 34. The internal distal groove 58 is configured to receive an internal distal static seal.

The tool flange 22a of this example further comprises a plurality of tool mounting blind holes 60. Each tool mounting blind hole 60 is threaded to be threadingly engaged by a threaded tool bolt. In this example, the tool mounting blind holes 60 are positioned radially between the internal distal groove 58 and the external distal groove 48 with respect to the central axis 34.

The tool flange 22a of this example further comprises a plurality of primary mounting holes 62. Each primary mounting hole 62 extends through the tool flange 22a in parallel with the central axis 34, here through the collar 42. Each primary mounting hole 62 is configured to receive a primary bolt therethrough. In this example, the primary mounting holes 62 are positioned radially inside the internal distal groove 58 with respect to the central axis 34.

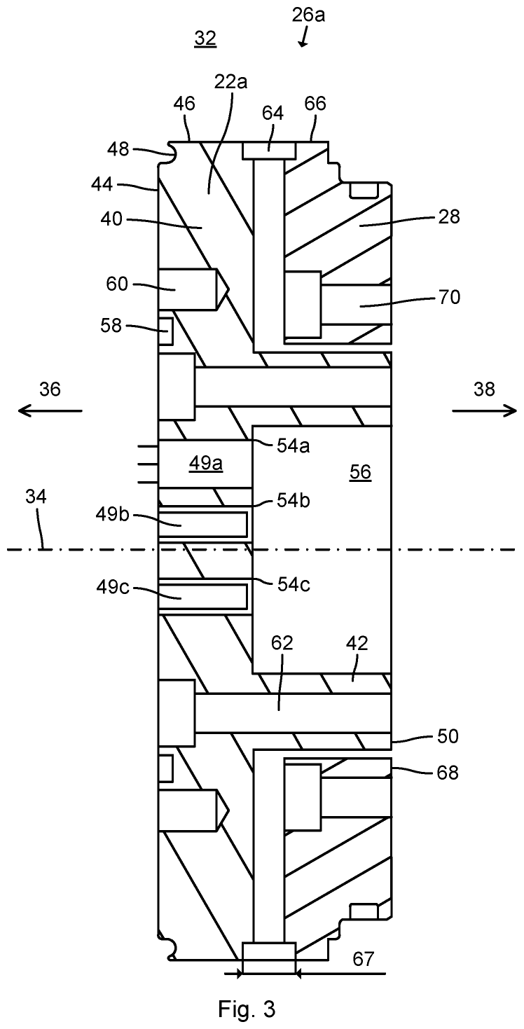

FIG. 3 schematically represents a cross-sectional side view of the mounting arrangement 26a. In addition to the tool flange 22a, the mounting arrangement 26a of this example comprises the secondary element 28 and the external proximal dynamic seal 64. The external proximal dynamic seal 64 is received in the external proximal groove 52.

The secondary element 28 comprises an external secondary surface 66. The external secondary surface 66 faces radially outwards with respect to the central axis 34 and towards the external region 32. The external secondary surface 66 is cylindrical and concentric with the central axis 34. In this example, the secondary element 28 surrounds the collar 42.

The secondary element 28 may be made of metal, such as titanium, aluminum or stainless steel, for example AISI 316 or AISI 316L stainless steels. The secondary element 28 may be an integral body, i.e. formed from a single piece of material. The external secondary surface 66 may have a surface roughness profile, where an arithmetic mean deviation of the roughness profile, Ra, is less than 2 μm, such as less than 1 μm, such as less than 0.8 μm.

The external primary surface 46 and the external secondary surface 66 have the same diameter. The external primary surface 46 and the external secondary surface 66 are therefore flush.

During operation of the industrial robot 10, the tool flange 22a can be driven to rotate relative to the secondary element 28. The external proximal dynamic seal 64 dynamically seals a secondary gap 67 between the external primary surface 46 and the external secondary surface 66.

The secondary element 28 comprises a proximal secondary surface 68 transverse to the central axis 34 and facing in the proximal direction 38. As shown in FIG. 3, the proximal primary surface 50 and the proximal secondary surface 68 lie in a common plane transverse to the central axis 34.

The secondary element 28 further comprises a plurality of secondary mounting holes 70. Each secondary mounting hole 70 passes through the secondary element 28 in parallel with the central axis 34. Each secondary mounting hole 70 is configured to receive a secondary bolt therethrough.

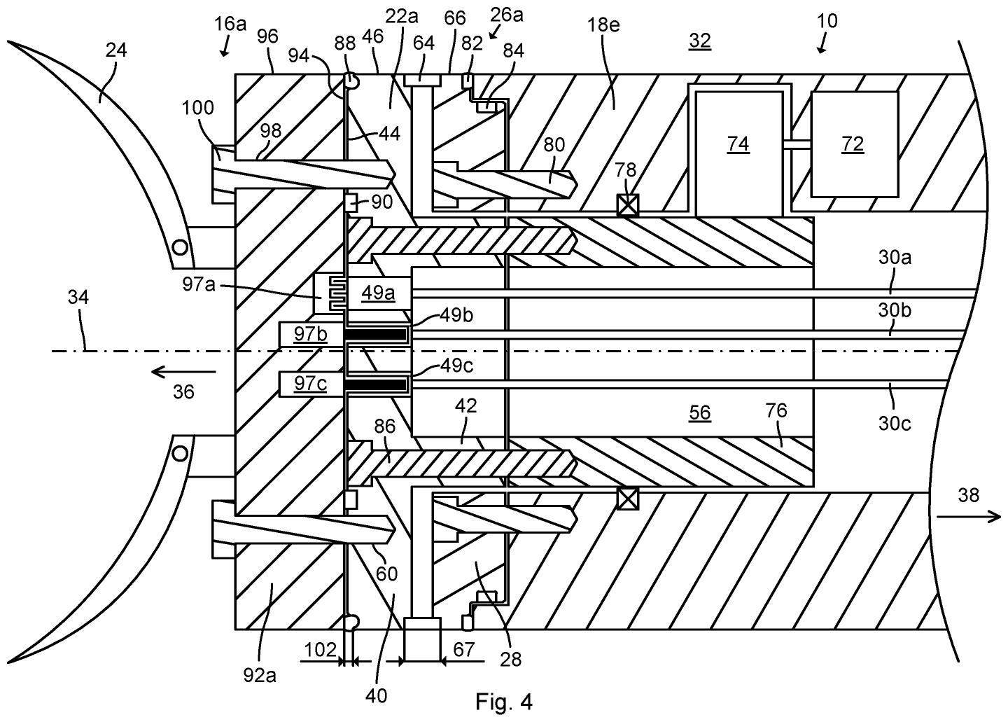

FIG. 4 schematically represents a cross-sectional side view of the fifth link 18e, the mounting arrangement 26a and the tool 16a. In this specific example, the fifth link 18e houses an electric motor 72 and a transmission 74. The electric motor 72 is arranged to drive the tool flange 22a to rotate relative to the fifth link 18e via the transmission 74. The industrial robot 10 comprises a rotatable output member 76. The output member 76 is positioned inside the fifth link 18e. The output member 76 is rotatable relative to the fifth link 18e about the central axis 34. The output member 76 is supported by bearings 78. The transmission 74 may comprise a gear wheel that meshes with the output member 76 to rotationally drive the output member 76.

The secondary element 28 is secured to the fifth link 18e with threaded secondary bolts 80 passing through a respective secondary mounting hole 70 and threadingly engaging respective blind holes in the fifth link 18e. The mounting arrangement 26a comprises an external proximal static seal 82. When the secondary element 28 is secured to the fifth link 18e, the external proximal static seal 82 is compressed to seal a gap between the external secondary surface 66 and an external surface of the fifth link 18e. The mounting arrangement 26a further comprises an internal proximal static seal 84. The internal proximal static seal 84 is positioned radially inside the external proximal static seal 82.

FIG. 4 further shows that the tool flange 22a is secured to the output member 76 with threaded primary bolts 86 passing through a respective primary mounting hole 62 and threadingly engaging respective blind holes in the output member 76.

In FIG. 4, the external distal static seal 88 of the tool flange 22a can be seen. The external distal static seal 88 is seated in the external distal groove 48 and encloses the tool flange 22a. The external distal static seal 88 may be made of rubber. Examples of suitable rubbers comprise M-Class rubbers under the ASTM standard D-1418, such as EPDM (ethylene propylene diene monomer) rubber. Alternatively, or in addition, the external distal static seal 88 may be made of a food grade material, such as an FDA (Food and Drug Administration) compliant material, i.e. a material that meets all of the FDA's guidelines for safe, direct contact with food. According to one variant, the external distal static seal 88 meets the IEC (International Electrotechnical Commission) standard 60529.

FIG. 4 also shows the internal distal static seal 90 of the tool flange 22a. The internal distal static seal 90 is seated in the internal distal groove 58. The internal distal static seal 90 may or may not be a food grade seal.

The tool 16a of this example comprises a tool base 92a. The tool base 92a may be made of metal, such as titanium, aluminum or stainless steel, for example AISI 316 or AISI 316L stainless steels. The tool base 92a may be an integral body, i.e. formed from a single piece of material. The gripper 24 is movable relative to the tool base 92a to perform various handling operations.

The tool base 92a comprises a proximal tool base surface 94. The proximal tool base surface 94 is here flat and transverse to the central axis 34. The proximal tool base surface 94 faces in the proximal direction 38.

The tool base 92a further comprises a cylindrical external tool base surface 96. The external tool base surface 96 faces radially outwards with respect to the central axis 34. The external tool base surface 96 faces towards the external region 32. The external tool base surface 96 is concentric with the central axis 34. The external tool base surface 96 may have a surface roughness profile, where an arithmetic mean deviation of the roughness profile, Ra, is less than 2 μm, such as less than 1 μm, such as less than 0.8 μm.

The tool base 92a further comprises a plurality of tool connectors 97a-97c, here a first tool connector 97a, a second tool connector 97b and a third tool connector 97c. The first tool connector 97a, the second tool connector 97b and the third tool connector 97c are here exemplified as a power and signal connector for connection to the first tool flange connector 49a, an air input connector for connection to the second tool flange connector 49b, and an air output connector for connection to the third tool flange connector 49c, respectively. As shown in FIG. 4, the pins of the first tool flange connector 49a are received by the first tool connector 97a, a pin of the second tool connector 97b is received by the second tool flange connector 49c, and a pin of the third tool connector 97c is received by the third tool flange connector 49c. In this way, the lines 30a-30c can be brought into communication with the tool 16a by a single movement of the tool 16a.

The tool base 92a of this example further comprises a plurality of tool mounting through holes 98. Each tool mounting through hole 98 extends through the tool base 92a in parallel with the central axis 34.

The tool 16a of this example is mounted to the tool flange 22a by passing threaded tool bolts 100 through the respective tool mounting through holes 98 and threadingly engaging the tool bolts 100 in the respective tool mounting blind holes 60.

As shown in FIG. 4, the external tool base surface 96 and the external primary surface 46 have the same diameter. The external tool base surface 96 and the external primary surface 46 are therefore flush when the tool 16a is secured to the tool flange 22a.

When the tool 16a is tightened to the tool flange 22a, the external distal static seal 88 seated in the external distal groove 48 is compressed by the proximal tool base surface 94. The shape of the external distal groove 48 causes the external distal static seal 88 to be compressed both in an axial direction and a radial direction with respect to the central axis 34. The external distal static seal 88 seals a primary gap 102 between the external tool base surface 96 and the external primary surface 46 without providing any dust pockets for contaminants. This provides a very hygienic design of the industrial robot 10 having high cleanability and a low accumulation of contaminants. This hygienic design is enabled by the tool flange 22a also for many prior art tools without requiring any modification thereof.

Furthermore, when the tool 16a is tightened to the tool flange 22a, the internal distal static seal 90 is compressed by the proximal tool base surface 94. The internal distal static seal 90 thereby provides a backup seal for the tool flange connectors 49a-49c.

FIG. 4 further shows the lines 30a-30c connected to the tool flange connectors 49a-49c. By routing the lines 30a-30c to the tool 16a through the internal region 56 and by sealingly closing the internal region 56 with the external distal static seal 88 and the internal distal static seal 90, the lines 30a-30c are securely protected against the harsh washdown processes.

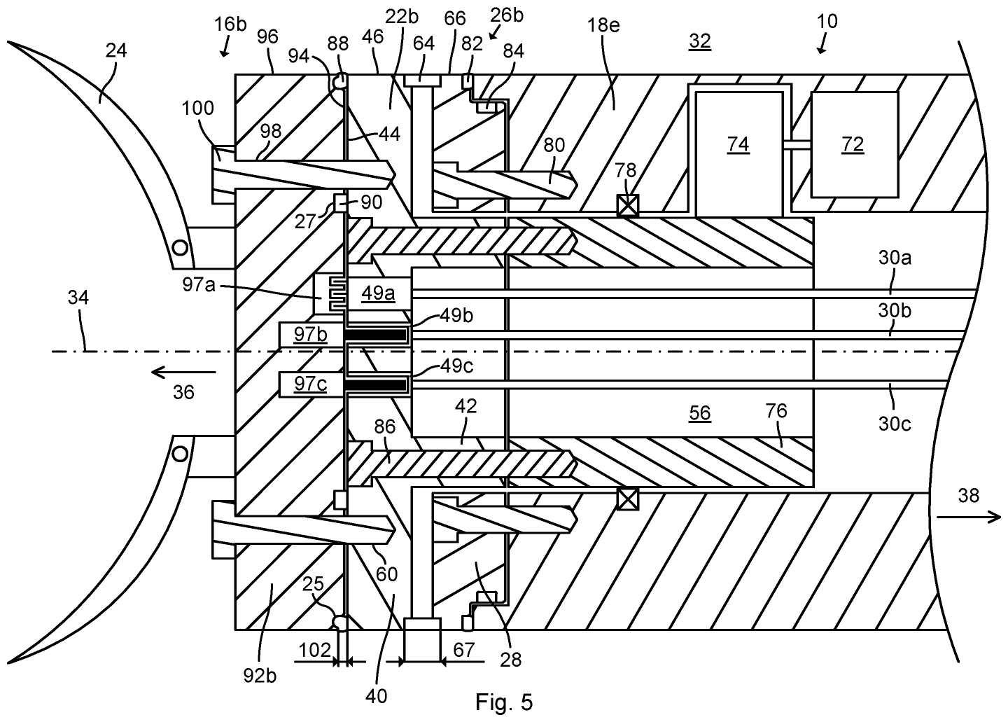

FIG. 5 schematically represents a cross-sectional side view of the fifth link 18e, a further example of a mounting arrangement 26b and a further example of a tool 16b mounted to the industrial robot 10. Mainly differences with respect to FIG. 4 will be described. The tool 16b comprises a tool base 92b having an external proximal tool base groove 25. The external proximal tool base groove 25 may have mirrored shape with respect to the external distal groove 48. Moreover, the external proximal tool base groove 25 has a corresponding relationship to the proximal tool base surface 94 and the external tool base surface 96 as the external distal groove 48 has to the distal surface 44 and the external primary surface 46. Also in FIG. 5, the external distal static seal 88 seals the primary gap 102 between the external tool base surface 96 and the external primary surface 46.

The tool base 92b further comprises an internal proximal groove 27. The internal proximal groove 27 has a mirrored shape with respect to the internal distal groove 58. Moreover, the internal proximal groove 27 has a corresponding relationship to the proximal tool base surface 94 as the internal distal groove 58 has to the distal surface 44. In FIG. 5, the internal distal static seal 90 is seated in the internal proximal groove 27 and seals against the distal surface 44. As a further example, the industrial robot 10 may comprise the tool 16b connected to the tool flange 22a.

While the present disclosure has been described with reference to exemplary embodiments, it will be appreciated that the present invention is not limited to what has been described above. For example, it will be appreciated that the dimensions of the parts may be varied as needed.

Accordingly, it is intended that the present invention may be limited only by the scope of the claims appended hereto.ABSTRACT

A tool flange for an industrial robot, the tool flange having a distal surface to which a tool for the industrial robot can be secured; an external primary surface facing outwards with respect to a central axis; an external distal groove enclosing the central axis and configured to receive an external distal static seal to seal a primary gap between the external primary surface and the tool when the tool is secured to the distal surface, the external distal groove separating the distal surface and the external primary surface; and a tool flange connector for being connected to a tool connector of the tool when the tool is secured to the distal surface, the tool flange connector being enclosed by the distal surface.

1. A tool flange for an industrial robot, the tool flange comprising:
a distal surface to which a tool for the industrial robot can be secured;
an external primary surface facing outwards with respect to a central axis;
an external distal groove enclosing the central axis and configured to receive an external distal static seal to seal a primary gap between the external primary surface and the tool when the tool is secured to the distal surface, the external distal groove separating the distal surface and the external primary surface; and
a tool flange connector for being connected to a tool connector of the tool when the tool is secured to the distal surface, the tool flange connector being enclosed by the distal surface.

2. The tool flange according to claim 1, wherein the external distal groove extends partly inside of the external primary surface in a plane transverse to the central axis.

3. The tool flange according to claim 1, wherein the external distal groove is curved and/or concave.

4. The tool flange according to claim 1, further comprising an internal distal groove in the distal surface inside of the external distal groove, the internal distal groove being configured to receive an internal distal static seal to seal against the tool when the tool is secured to the distal surface.

5. The tool flange according to claim 1, further comprising a circular external proximal groove for receiving an external proximal dynamic seal to seal a secondary gap between the external primary surface and a secondary element.

6. The tool flange according to claim 5, wherein the external primary surface is cylindrical and extends from the external distal groove to the external proximal groove.

7. A mounting arrangement for an industrial robot, the mounting arrangement comprising a tool flange having a distal surface to which a tool for the industrial robot can be secured;
an external primary surface facing outwards with respect to a central axis;
an external distal groove enclosing the central axis and configured to receive an external distal static seal to seal a primary gap between the external primary surface and the tool when the tool is secured to the distal surface, the external distal groove separating the distal surface and the external primary surface; and
a tool flange connector for being connected to a tool connector of the tool when the tool is secured to the distal surface, the tool flange connector being enclosed by the distal surface and a secondary element, wherein the secondary element includes an external secondary surface facing outwards with respect to the central axis, wherein the external primary surface and the external secondary surface are cylindrical and have the same diameter.

8. The mounting arrangement according to claim 7, when comprising a tool flange and the external proximal dynamic seal, wherein the external proximal dynamic seal seals the secondary gap between the external primary surface and the external secondary surface.

9. A tool for an industrial robot, the tool having a tool base comprising:
a proximal tool base surface for being secured to a distal surface of a tool flange of the industrial robot;
an external tool base surface facing outwards with respect to a central axis;
an external proximal tool base groove enclosing the central axis and configured to receive an external distal static seal to seal a primary gap between the external tool base surface and the tool flange when the tool is secured to the distal surface, the external proximal tool base groove separating the proximal tool base surface and the external tool base surface; and
a tool connector for being connected to a tool flange connector of the tool flange when the tool is secured to the distal surface, the tool connector being enclosed by the proximal tool base surface.

10. An industrial robot comprising a tool flange having a distal surface to which a tool for the industrial robot can be secured;
an external primary surface facing outwards with respect to a central axis;
an external distal groove enclosing the central axis and configured to receive an external distal static seal to seal a primary gap between the external primary surface and the tool when the tool is secured to the distal surface, the external distal groove separating the distal surface and the external primary surface; and
a tool flange connector for being connected to a tool connector of the tool when the tool is secured to the distal surface, the tool flange connector being enclosed by the distal surface, a mounting arrangement when having a tool flange and the external proximal dynamic seal, wherein the external proximal dynamic seal seals the secondary gap between the external primary surface and the external secondary surface.

11. The industrial robot according to claim 10, further comprising a tool connected to the tool flange.

12. The tool flange according to claim 2, wherein the external distal groove is curved and/or concave.

13. The tool flange according to claim 2, further comprising an internal distal groove in the distal surface inside of the external distal groove, the internal distal groove being configured to receive an internal distal static seal to seal against the tool when the tool is secured to the distal surface.

14. The tool flange according to claim 2, further comprising a circular external proximal groove for receiving an external proximal dynamic seal to seal a secondary gap between the external primary surface and a secondary element.
